(19) United States
(12) Patent Application Publication
(10) Pub. No.: US 2006/0094432 A1
(43) Pub. Date: May 4, 2006

(54) Handoff method for mobile communication system

(76) Inventors: Jen-Chun Chang, Taipei City (TW); Tzeng-Chih Chiou, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 10/904,302

(22) Filed: Nov. 3, 2004

(51) Int. Cl. H04Q 7/20

(52) U.S. Cl. 455/439; 455/436

(57) ABSTRACT

A method of performing a handoff in a mobile communication system includes measuring signal strength of signals received by a mobile station from an active base station and comparing the measured signal strength of the active base station with a first threshold value. If the measured signal strength of the active base station is less than the first threshold value, the signal strength of neighboring base stations is measured for identifying a candidate base station, which is a neighboring base station with the highest signal strength. The method also includes handing off from the active base station to the candidate base station if the measured signal strength of the active base station is less than the first threshold value and greater than a second threshold value, and if signal strength of the candidate base station is greater than the signal strength of the active base station by a predetermined value.

### BACKGROUND OF INVENTION

1. Field of the Invention

The present invention relates to a method of handing off from one base station to another with a mobile station, and more specifically, to a method of determining whether to handoff based on comparisons of the signal strength with predetermined thresholds and constants.

2. Description of the Prior Art

In general, for effective management of frequency resources, mobile communication systems are divided into small cell areas, and a mobile station is provided with service from a base station in a cell to which it belongs. When a mobile station travels from a cell in service to another cell, a handoff is performed for the mobile station to maintain continuous service.

Please refer to FIG. 1. FIG. 1 is a diagram of a mobile station 20 communicating with a mobile communication system 10 containing a plurality of cells 15. Each of the cells 15 has a corresponding base station. The base station that the mobile station 20 is currently communicating with is called an active base station A. The base stations of other nearby cells 15 will be referred to as neighboring base stations B₁-B₆.

As stated above, when the mobile station 20 travels from one cell 15 to another, the mobile communication system 10 performs a handoff to maintain communication with the mobile station 20. When channel quality of the active base station A becomes lower than a threshold during a call, the channel to the active base station A is disconnected and thereafter, a new channel is assigned from one of the neighboring base stations B₁-B₆.

Please refer to FIG. 2. FIG. 2 is a flowchart illustrating a method of determining if the mobile station 20 needs to handoff to another base station according to the prior art. Steps contained in the flowchart will be explained below.

Step 50: Start;

Step 52: Find a candidate base station K, such that the measured signal strength power P(K) of the candidate base station K is the maximum measured signal strength power among the active base station A and the neighboring base stations B₁-Bₙ;

Step 54: Determine if the measured signal strength power P(K) of the candidate base station minus the measured signal strength power P(A) of the active base station is greater than a constant value C; if so, go to step 56; if not, go to step 58;

Step 56: The mobile station 20 handoffs to the candidate base station K; and

Step 58: The mobile station 20 does not handoff, and will continue to communicate with the active base station A.

With the prior art method, as long the power of signals received from a candidate base station K is stronger than the power of signals received from the active base station A by a constant value C, the mobile station 20 will handoff to the candidate base station K. Therefore, using a small value for the constant C will ensure that the mobile station 20 receives the best signal reception. However, a small value of the constant C also means that the mobile station 20 will perform frequent handoff operations, which will put more load on the mobile station 20 and drain the battery of the mobile station 20 more quickly.

When the mobile station 20 is not being used for making a call, the mobile station 20 will spend a majority of its time in a power saving mode, also referred to as sleep mode. While in sleep mode, the mobile station 20 will periodically wakeup to communicate with the mobile communication system 10, to check for messages, and to determine if the mobile station 20 needs to handoff to another base station. Frequent handoffs during the wakeup process of the mobile station 20 will lengthen the wakeup period, and waste more battery energy.

### SUMMARY OF INVENTION

It is therefore an objective of the claimed invention to provide an improved method for determining if a handoff is necessary in a mobile communication system in order to solve the above-mentioned problems.

According to the claimed invention, a method of performing a handoff in a mobile communication system is proposed. The method includes measuring signal strength of signals received by a mobile station from an active base station and comparing the measured signal strength of the active base station with a first threshold value. If the measured signal strength of the active base station is less than the first threshold value, the signal strength of neighboring base stations is measured for identifying a candidate base station, which is a neighboring base station with the highest signal strength. The method also includes handing off from the active base station to the candidate base station if the measured signal strength of the active base station is less than the first threshold value and greater than a second threshold value, and if signal strength of the candidate base station is greater than the signal strength of the active base station by a first predetermined value.

It is an advantage of the claimed invention that the claimed invention method compares against a plurality of threshold values when deciding whether to handoff the mobile station to another base station. The claimed method reduces the probability of performing a handoff, thereby saving battery energy and reducing the amount of time needed to perform a wakeup operation of the mobile station. Moreover, the claimed method is simple to implement in the mobile station and mobile communication system, and does not increase the load on the mobile station's processor.

These and other objectives of the claimed invention will no doubt become obvious to those of ordinary skill in the art after reading the following detailed description of the preferred embodiment, which is illustrated in the figure below.

### BRIEF DESCRIPTION OF DRAWINGS

FIG. 1 is a diagram of a mobile station communicating with a mobile communication system containing a plurality of cells.

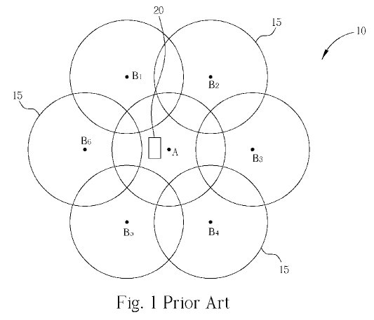

FIG. 2 is a flowchart illustrating a method of determining if the mobile station needs to handoff to another base station according to the prior art.

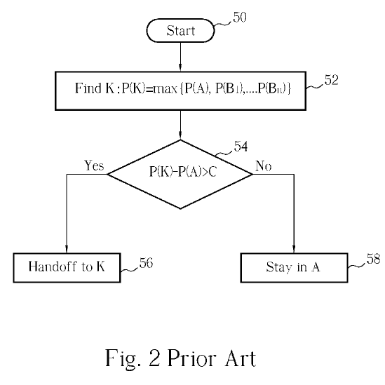

FIG. 3 is a flowchart illustrating a method of determining if the mobile station needs to handoff to another base station according to the present invention.

### DETAILED DESCRIPTION

The present invention offers an improvement over the prior art method of determining if the mobile station needs to hand off to another base station. The improvement is a result of comparing the measured signal strength power with a plurality of threshold values instead of simply seeing if the measured signal strength power P(K) of the candidate base station K is greater than the measured signal strength power P(A) of the active base station A by a constant value C. By using a plurality of threshold values, the probability of handing off is lowered, and the mobile station will only hand off when it is truly necessary. By reducing the number of handoffs performed, less energy is used from the battery.

Since the present invention is an improvement of the prior art method of handing off, the same terms and symbols used to describe the prior art method will also be used to describe the present invention.

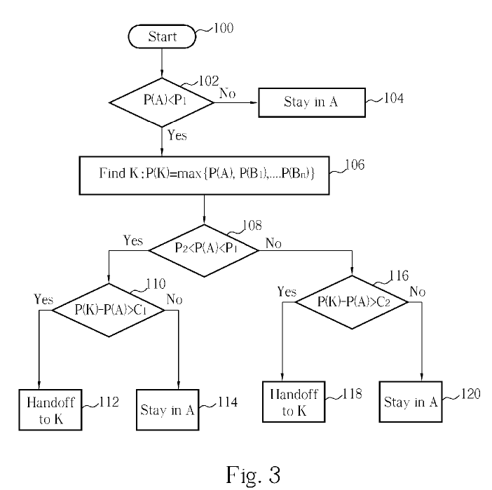

Please refer to FIG. 3. FIG. 3 is a flowchart illustrating a method of determining if the mobile station 20 needs to handoff to another base station according to the present invention. Steps contained in the flowchart will be explained below.

Step 100: Start;

Step 102: Determine if the measured signal strength power P(A) of the active base station A is less than a first threshold value P₁; if so, go to step 106; if not, go to step 104;

Step 104: The mobile station 20 does not handoff, and will continue to communicate with the active base station A;

Step 106: Find a candidate base station K, such that the measured signal strength power P(K) of the candidate base station K is the maximum measured signal strength power among the active base station A and the neighboring base stations B₁-Bₙ;

Step 108: Determine if the measured signal strength power P(A) of the active base station is less than the first threshold value P₁ and greater than a second threshold value P₂; if so, go to step 110; if not, go to step 116;

Step 110: Determine if the measured signal strength power P(K) of the candidate base station minus the measured signal strength power P(A) of the active base station is greater than a first constant value C₁; if so, go to step 112; if not, go to step 114;

Step 112: The mobile station 20 handoffs to the candidate base station K;

Step 114: The mobile station 20 does not handoff, and will continue to communicate with the active base station A;

Step 116: Determine if the measured signal strength power P(K) of the candidate base station minus the measured signal strength power P(A) of the active base station is greater than a second constant value C₂; if so, go to step 118; if not, go to step 120;

Step 118: The mobile station 20 handoffs to the candidate base station K; and

Step 120: The mobile station 20 does not handoff, and will continue to communicate with the active base station A.

In the above method, the first and second threshold values P₁ and P₂ and the first and second constant values C₁ and C₂ are all constants. As an example, the first and second threshold values P₁ and P₂ may have values of −80 dBm and −90 dBm, respectively. The first and second constant values C₁ and C₂ may have values of 3 dB and 1 dB, respectively. Of course, these values are only provided as an example, and a variety of other values can also be used with the present invention.

The present invention compares the measured signal strength power P(A) of the active base station with a plurality of threshold values. In addition, determinations are made as to whether the measured signal strength power P(K) of the candidate base station is greater than the measured signal strength power P(A) of the active base station by a plurality of constant values. Although only two threshold values and two constant values were used in the flowchart in FIG. 3, it will be appreciated that the present invention method can compare the measured signal strength powers with many different threshold values and constant values. Of course, the more threshold values used in the present invention, the more complicated the algorithm will be. At the same time, however, the chance of requiring a handoff will also be lowered.

As can be seen from the flowchart in FIG. 3, even if the measured signal strength power P(A) of the active base station is less than the first threshold value, the mobile station does not have to perform a handoff operation. Therefore, less energy stored in the battery of the mobile station will be used for handing off the mobile station from one base station to another.

In contrast to the prior art, the present invention method compares against a plurality of threshold values when deciding whether to handoff the mobile station to another base station. The claimed method reduces the probability of performing a handoff, thereby saving battery energy and reducing the amount of time needed to perform a wakeup operation of the mobile station. Moreover, the claimed method is simple to implement in the mobile station and mobile communication system, and does not increase the load on the mobile station's processor. While the present invention can be implemented in a code division multiple access (CDMA) communication system, the present invention method can also be implemented in a variety of other communication systems, such as a global system for mobile communications (GSM) system.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for performing a handoff in a mobile communication system, comprising the steps of:
measuring signal strength of signals received by a mobile station from an active base station;
comparing the measured signal strength of the active base station with a first threshold value;
measuring signal strength of neighboring base stations if the measured signal strength of the active base station is less than the first threshold value;
identifying a candidate base station, which is one of neighboring base stations with the highest signal strength; and
handing off from the active base station to the candidate base station if the measured signal strength of the active base station is less than the first threshold value and greater than a second threshold value, and if signal strength of the candidate base station is greater than the signal strength of the active base station by a first predetermined value.

2. The method of claim 1, further comprising continuing to receive signals from the active base station if the measured signal strength of the active base station is less than the first threshold value and greater than the second threshold value, and if the signal strength of the candidate base station is not greater than the signal strength of the active base station by the first predetermined value.

3. The method of claim 1, further comprising handing off from the active base station to the candidate base station if the measured signal strength of the active base station is less than the first and second threshold values, and if the signal strength of the candidate base station is greater than the signal strength of the active base station by a second predetermined value.

4. The method of claim 3, further comprising continuing to receive signals from the active base station if the measured signal strength of the active base station is less than the first and second threshold values, and if the signal strength of the candidate base station is not greater than the signal strength of the active base station by the second predetermined value.

5. The method of claim 1, further comprising continuing to receive signals from the active base station if the measured signal strength of the active base station is greater than or equal to the first threshold value.

6. The method of claim 1, wherein the mobile communication system is a code division multiple access (CDMA) communication system.

7. The method of claim 1, further comprising waking up from a power saving mode before measuring the signal strength of signals received from an active base station.

8. A method for performing a handoff in a mobile communication system, comprising the steps of:
waking up from a power saving mode;
measuring signal strength of signals received by a mobile station from an active base station;
comparing the measured signal strength of the active base station with a first threshold value;
measuring signal strength of neighboring base stations if the measured signal strength of the active base station is less than the first threshold value;
identifying a candidate base station, which is one of neighboring base stations with the highest signal strength;
handing off from the active base station to the candidate base station if the measured signal strength of the active base station is less than the first threshold value and greater than a second threshold value, and if signal strength of the candidate base station is greater than the signal strength of the active base station by a first predetermined value; and
handing off from the active base station to the candidate base station if the measured signal strength of the active base station is less than the first and second threshold values, and if the signal strength of the candidate base station is greater than the signal strength of the active base station by a second predetermined value.

9. The method of claim 8, further comprising continuing to receive signals from the active base station if the measured signal strength of the active base station is less than the first threshold value and greater than the second threshold value, and if the signal strength of the candidate base station is not greater than the signal strength of the active base station by the first predetermined value.

10. The method of claim 8, further comprising continuing to receive signals from the active base station if the measured signal strength of the active base station is less than the first and second threshold values, and if the signal strength of the candidate base station is not greater than the signal strength of the active base station by the second predetermined value.

11. The method of claim 8, further comprising continuing to receive signals from the active base station if the measured signal strength of the active base station is greater than or equal to the first threshold value.

12. The method of claim 8, wherein the mobile communication system is a code division multiple access (CDMA) communication system.
